(19) United States
(12) Patent Application Publication
(10) Pub. No.: US 2007/0164876 A1
(43) Pub. Date: Jul. 19, 2007

(54) Receiver for different frequencies and modulations

(75) Inventors: Gerald Ostrander, Davison, MI (US); David J. Reimus, West Bloomfield, MI (US); Tejas Desai, Troy, MI (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/652,367

(22) Filed: Jan. 11, 2007

Related U.S. Application Data
(60) Provisional application No. 60/758,056, filed on Jan. 11, 2006.

(51) Int. Cl. G08C 19/00

(52) U.S. Cl. 340/825.72; 340/447; 340/426.36; 455/132; 340/825.69; 340/5.72

(57) ABSTRACT

An example wireless communication system receives signals from several wireless systems such as for example a tire pressure monitoring (TPM) system, a remote keyless entry (RKE) system, and a passive start and entry (PASE) system. Each of the systems provides different signals of different frequencies and modulations. The example receiver includes multiple channels that correspond to the signals from each of the example systems. Each of the channels is operable concurrently to monitor and receive signals from each of the system according to a desired hierarchy. The multiple channels eliminate transmission collisions between signals from the different systems.

### CROSS REFERENCE TO RELATED APPLICATION

The application claims priority to U.S. Provisional Application No 60/758,056 filed on Jan. 11, 2006.

### BACKGROUND OF THE INVENTION

This invention generally relates to a receiver for receiving signals from various vehicle systems. More particularly, this invention relates to a multi-channel receiver for receiving signals from different vehicle system of different transmission frequencies and modulations.

A radio frequency receiver provides for communication between a vehicle controller and various systems such as a tire pressure monitoring system and a remote keyless entry system. Current receivers include a single channel for receiving a single frequency. Different transmission of the same frequency can cause interferences and disruption of incoming information. One way to prevent collisions if to operate each system within the vehicle operates at different frequencies or modulations. However, this solution requires several different receivers to communicate with each of the various vehicle systems.

Disadvantageously, the use of several different receivers is cost prohibitive and therefore not desirable. Further, a single receiver can only receive on signal at a time, and therefore can miss signals from other systems while receiving a signal from another system. The delay in receiving a signal caused by switching the receiver is not desirable to a vehicle operator.

Accordingly, it is desirable to design and develop a receiver that operates to receive signals of different modulations and frequencies that minimizes missed signals or signal overlap.

### SUMMARY OF THE INVENTION

An example wireless communication system includes a multi-channel receiver for communicating with various systems transmitting signals of different frequencies and modulations.

An example wireless communication system receives signals from several wireless systems such as for example a tire pressure monitoring (TPM) system, a remote keyless entry (RKE) system, and a passive start and entry (PASE) system. An example receiver receives various wireless signals according to a desired control algorithm.

Each of the systems transmits different signals of different frequencies and modulations. The example receiver includes multiple channels that correspond to the signals from each of the example systems. Each of the channels is operable concurrently to monitor and receive signals from each of the system according to a desired hierarchy. The multiple channels eliminate transmission collisions between signals from the different systems. Because each system transmits on a different frequency, therefore a signal on one frequency will not interfere with the receipt of a signal on another frequency.

Accordingly, the example system and receiver receives multiple signals of different frequencies and modulations to avoid transmission collisions, and substantially prevent the complete missing of any radio frequency signals for a vehicle wireless communication system.

These and other features of the present invention can be best understood from the following specification and drawings, the following of which is a brief description.

### BRIEF DESCRIPTION OF THE DRAWINGS

FIG. 1 is a schematic view of an example system for receiving wireless communication from various vehicle systems.

FIG. 2 is a schematic view of duty cycle operation of the example system.

### DETAILED DESCRIPTION OF THE PREFERRED EMBODIMENT

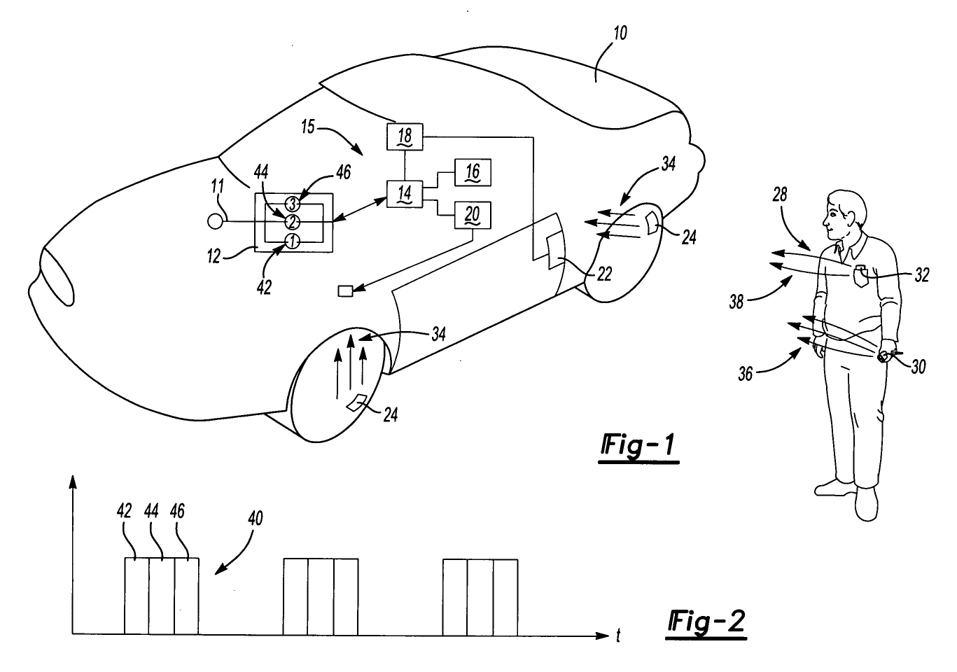

Referring to FIG. 1, an example vehicle 10 includes a wireless communication system 15 for communicating with several wireless systems. The example vehicle includes a tire pressure monitoring (TPM) system 16, a remote keyless entry (RKE) system 18, and a passive start and entry (PASE) system 20. The example communication system 15 may be utilized for other multiple wireless system applications and is disclosed by way of example in view of various systems within the vehicle 10.

The wireless communication system includes a receiver 12 for receiving the various wireless signals according to a control algorithm performed by a controller 14. The example controller 14 controls the receiver 12 and distributes received information to one of the example systems, 16, 18, 20. The example PASE system 20 may enable an ignition switch 25 and actuate a locking device 22 to open a car door. The example TPM system 16 may display relevant information to a user 28. The RKE system 18 may actuate the locking device 22 responsive to actuation of a key fob 30. Each action is controlled according to the specific system requirements and algorithms. The example controller 14 can be a dedicated controller that only operates the receiver 12 or part of a more inclusive controller that controls other functions of the vehicle. A worker skilled in the art would understand how to program and operate known controllers to provide the disclosed functions and receiver control.

Each of the systems 16, 18, 20 provides different signals of different frequencies and modulations. Each specific modulation and frequency is chosen to provide desired signal and data transfer characteristics. The example receiver 12 includes a first channel 42, a second channel 44, and a third channel 46 that correspond to the signals from each of the example systems 16, 18, 20. As appreciated, although the example receiver 12 includes three channels, the receiver can include any number of channels. Each of the channels 42, 44, 46 is operable concurrently to monitor and receive signals from each of the system according to a desired hierarchy. The multiple channels eliminate transmission collisions between signals from the different systems 16, 18, 20. This is because each system transmits on a different frequency and therefore a signal on one frequency will not interfere with the receipt of a signal on another frequency.

The example TPM system 16 includes transmitters 24 disposed in each of the tires of the vehicle 10 to send a wireless radio frequency signal 34 including information indicative of conditions within each of the tires. The example transmitters 24 send this signal 34 at a frequency of 315 MHz with Frequency Shift Keyed Modulation (FSK).

The example RKE system 18 receives a signal 36 from a key fob 30 that provides information utilized to authorize and operate actuation of the locking device 22 and operation of the vehicle 10. The example key fob 30 transmits the signal 36 at a frequency of 316 MHz with Amplitude Shift Keyed modulation (ASK).

The example PASE system 20 receives signals 38 from a passive authorization device 32 carried by an operator 28. The passive authorization device 32 transmits the signal 38 at a frequency of 314 MHz with FSK modulation. As appreciated, the example frequencies and modulations can be adjusted to accommodate other systems and desired transmission protocols. The example different frequencies prevent the collision of different signal broadcast on the same frequency as is the case when utilizing a receiver with a single channel.

Referring to FIG. 2, the example receiver 12 is operated according to a desired operation algorithm. The example receiver 12 is operated according to a duty cycle where the receiver 12 is cycled between an off condition and an active on condition. In the active condition, the receiver 12 monitors all of the channels for signals of that frequency and modulation. In the Example, an on cycle is indicated schematically at 40 and includes the substantially concurrent monitoring with all three channels 42, 44, and 46. The receiver 12 monitors the surrounding area until a recognized signal is received. The controller 14 then operates the receiver 12 to switch to that recognized channel to receive the desired signal.

The recognition of the signal can includes the receipt of signal of a specific frequency and modulation with a received signal strength above a desired level. The receiver 12 can be operated to disregard signals below the desired signal strength level to improve operation.

In operation, the receiver 12 is cycled on to monitor each channel 42, 44, and 46. Each channel operates substantially concurrently to find and receive a corresponding signal. If no signal is received, the receiver 12 can be shut down to conserve power according to a defined power operation protocol. For example, when a vehicle is in a parked and not running condition, the receiver 12 can be cycled to monitor for a signal from the RKE system 18 or the PASE system 20.

When a signal is received, the receiver 12 is actuated to receive the signal in its entirety and distribute that information to the corresponding system. In the event that multiple signals are received at the same time, the controller 14 can evaluate which signal to process first according to a desired hierarchy. For example, the RKE signal 36 may take priority over the TPM signal 24, and the PASE signal 38 take priority over all other signals.

Accordingly, the example system and receiver 12 receives multiple signals of different frequencies and modulations to avoid transmission collisions, and substantially prevent the complete missing of any radio frequency signals for a vehicle wireless communication system 15.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A communication system for a motor vehicle comprising:
a receiver including a plurality of channels that are each configured to receive a desired radio frequency signal; and
a controller for controlling receipt of signals on the plurality of channels.

2. The system as recited in claim 1, wherein the receiver monitors the plurality of channels for a signal corresponding to one of the plurality of channels desired radio frequency signal.

3. The system as recited in claim 2, wherein the receiver monitors the plurality of channels concurrently.

4. The system as recited in claim 2, wherein the controller cycles the receiver between an on condition that monitors radio signals and an off condition.

5. The system as recited in claim 3, wherein the receiver engages one of the plurality of channels responsive to receiving a radio signal corresponding to the one channel.

6. The system as recited in claim 5, wherein the receiver detects the one of the plurality of signals responsive to a received signal strength for the desired radio signal being above a desired level.

7. The system as recited in claim 1, wherein one of the plurality of channels receives a Frequency Shift Keyed signal from a tire pressure monitoring transmitter.

8. The system as recited in claim 1, wherein one of the plurality of channels receives an Amplitude Shift Keyed signal from a remote keyless entry system.

9. The system as recited in claim 1, wherein one of the plurality of channels receives a Frequency Shift Keyed signal from a passive start and entry system.

10. The system as recited in claim 1, wherein each of the plurality of channels receives a radio frequency signal at a different frequency.

11. A method of operating a communication system for a motor vehicle comprising the steps of:
a) monitoring a plurality of channels concurrently with a receiver disposed within a motor vehicle;
b) switching to a single one of the plurality of channels responsive to detecting a radio frequency signal corresponding one of the plurality of channels; and
c) receiving the radio frequency signal on the one of the plurality of channels.

12. The method as recited in claim 11, wherein a controller cycles the receiver between an on condition to monitor the plurality of channels concurrently, and an off condition.

13. The method as recited in claim 11, wherein the step of detecting a radio frequency signal includes detecting a received signal strength of a radio frequency above a desired value.

14. The method as recited in claim 11, including the step of monitoring the plurality of channels for a remote keyless entry signal and a tire pressure monitoring signal of a different radio frequency concurrently.

15. The method as recited in claim 11, including the step of monitoring the plurality of channels for a passive start and entry signal and a tire pressure monitoring signal of a different radio frequency concurrently.
